(19) United States
(12) Patent Application Publication
(10) Pub. No.: US 2007/0212964 A1
(43) Pub. Date: Sep. 13, 2007

(54) SELF-ADHESIVE COMPOSITION AND ITS USE

(75) Inventors: KLAUS MASSOW, Hamburg (DE); STEPHAN SCHONBOM, Tornesch (DE); STEPHAN ZOLLNER, Buchholz / Nordheide (DE); SVEN HANSEN, Hamburg (DE)

Correspondence Address: NORRIS, MCLAUGHLIN & MARCUS, PA, 875 THIRD AVENUE, 18TH FLOOR, NEW YORK, NY, 10022, US

(73) Assignee: TESA AKTIENGESELLSCHAFT, Hamburg (DE)

(21) Appl. No.: 11/679,965

(22) Filed: Feb. 28, 2007

(30) Foreign Application Priority Data
Mar. 8, 2006 (DE) 10 2006 011 112.5

(51) Int. Cl. B32B 27/12; B32B 5/16; B32B 7/12; C04B 37/00

(52) U.S. Cl. 442/151; 428/323; 428/343; 156/325

(57) ABSTRACT

A pressure-sensitive self-adhesive composition capable of compensating for substrate unevennesses comprises a base adhesive and an additive, wherein the additive is a microparticulate additive which is insoluble in the base adhesive, does not crosslink with the base adhesive and has a bulk density in the range from 0.05 g/cm³ to 0.25 g/cm³ and an averaged particle diameter in the micrometer range. Adhesive coatings and self-adhesive sheet structures formed from the pressure-sensitive self-adhesive composition are also disclosed.

The invention relates to a pressure-sensitive self-adhesive composition comprising a base adhesive and a microparticulate additive, to the use of this self-adhesive composition for producing self-adhesive sheet structures, to an adhesive coating comprising such a self-adhesive composition, and to a method of coating a sheet structure.

Self-adhesive products frequently take the form of sheet structures coated at least partly with a self-adhesive composition in the form of an adhesive coating (or adhesive film). Such sheet structures may either have a backing—as tapes, labels and films, for instance—or else be of unbacked form (i.e. having no separate backing). Bonding to the substrate is generally achieved by exertion of a gentle pressure on the top face of the self-adhesive product. Pressure-sensitive self-adhesive compositions of this kind, which enter directly into a bond with the substrate when brought into contact with that substrate are also referred to as “pressure-sensitive adhesives” (PSAs). The quality of the bond achieved in this case depends substantially on the magnitude of the pressure exerted and on the properties of the self-adhesive composition and of the substrate.

Particularly in the case of a rough surface or uneven substrate, the problem occurs with such self-adhesive products that the adhesive bond produced is only a weak one, with little mechanical load-bearing capacity. This is a consequence of the fact that on the uneven substrate a considerable proportion of the self-adhesive composition's bond area does not come into contact with the substrate at all and is therefore unable to contribute to the bond, the part of the bond area in question being that located, for example, over relatively small depressions or indentations in the substrate, since a bond can be achieved on such a substrate exclusively via its elevations. This is a particular problem when two parts are to be joined to one another by means of a self-adhesive product, such as a double-sided adhesive or self-adhesive tape, and one or even both of the parts to be joined has or have a rough surface. In that case the roughness of the surface can no longer be compensated by any flexibility in the backing of a self-adhesive sheet structure, resulting in a particularly weak adhesive bond.

One way of ensuring bonding even on uneven bases is to equip the self-adhesive sheet structure with the capacity to compensate substrate unevenness. This can be achieved, for instance, by an interlayer which compensates the volume of the substrate and is located between the backing and the self-adhesive composition. A compensating interlayer of this kind must be elastic or highly viscous and must also be capable of firm mechanical connection to the backing on the one hand and the self-adhesive composition on the other. By pressing the self-adhesive sheet structure onto the substrate, the composition used as the compensating interlayer is compressed more strongly at the sites of greater pressure (elevations in the substrate) than at the points of lower pressure (depressions in the substrate), or even flows from the points of greater pressure to the sites of lower pressure. In this way, any unevenness is compensated for, so that the entire bond area is brought into contact with the substrate and, as a result, a strong bond can be achieved. It is necessary, though, for the compensating interlayer to be sufficiently thick, in order to be able actually to compensate the substrate unevenness present.

The application of such a separate compensating interlayer, however, as compared with conventional self-adhesive sheet structures, necessitates at least one additional step, namely the application of said interlayer. To simplify the method, therefore, attempts are made to design the self-adhesive composition itself as a compensating layer, as a kind of cushion of composition. In principle, by virtue of the flow behaviour their viscous fractions endow them with, self-adhesive compositions are highly suitable for serving as the compensating layer.

The most important constituent such a self-adhesive composition comprises is an adhesive component, the base adhesive, which can in turn comprise different constituents, such as adhesive constituents such as tackifier resins and structure-controlling constituents such as plasticizers, crosslinkers or crosslinker assistants. Base adhesives of this kind, however, are relatively expensive to prepare and, moreover, are often not readily biodegradable. For this reason, attempts are typically made to minimize the absolute amount of base adhesive on a self-adhesive sheet structure. In other words, the self-adhesive composition is frequently admixed with filler additives which are intended to expand the overall volume of the self-adhesive composition and so minimize the coat weight of base adhesive in the self-adhesive composition.

It is known in principle to use additives such as colorants, fillers or expanders as an admixture to self-adhesive compositions. Additives employed are conventionally those substances which are intended to modify certain physical properties of the self-adhesive composition: for example, as colorants, titanium dioxide, or, as fillers, mineral substances such as talc, calcium carbonate, clay, silicon dioxide, mica, wollastonite, feldspar, aluminosilicates, aluminium oxides or heavy spar. Besides natural mineral substances of this kind, synthetic mineral structures, such as glass microbeads or ceramic microbeads, for example, or organic structures, such as wood in the form of shavings, are likewise used as fillers.

Additives of this kind are added to the self-adhesive composition typically in an admixture of 0% by weight to 50% by weight. Where, however, greater amounts of such additives are added to a self-adhesive composition, the properties of the resultant self-adhesive composition deviate significantly in some cases from those of the pure base adhesive. In particular, the higher the fraction of additives, the greater the reduction in the adhesiveness of the self-adhesive composition. Overall this means that only small weight fractions of the base adhesive in the self-adhesive composition can be replaced without detracting significantly from its suitability as a self-adhesive composition. For instance, it is entirely possible to produce self-adhesive compositions with an additives weight fraction of more than 30%, but such compositions are generally no longer suitable for producing self-adhesive sheet structures. Accordingly, in the case of such additives, only a small mass fraction of additives can be added to the self-adhesive composition. A small mass fraction of additives, however, means that likewise only a small fraction of the total volume of the self-adhesive composition is replaced by the additive. If, therefore, in the case of a self-adhesive composition which compensates substrate unevenness, the thickness of the layer of self-adhesive composition has to be significantly greater than in the case of a conventional self-adhesive tape, then it is necessary, when using a conventional additive, to employ, per unit area, a relatively large amount of the base adhesive, which is disadvantageous from the standpoints of economics and environment.

It was an object of the invention, therefore, to provide a pressure-sensitive self-adhesive composition which is suitable for producing PSA sheet structures which attach particularly well to uneven bases, and which at the same time contains only a low fraction of base adhesive, without any significant consequent deterioration in the adhesive properties of the self-adhesive composition. A further object was to provide for the use of a pressure-sensitive self-adhesive composition compensating substrate unevenness for the purpose of producing self-adhesive sheet structures; an adhesive coating comprising this self-adhesive composition; a self-adhesive sheet structure comprising such an adhesive coating; and a method of producing such sheet structures.

This object has surprisingly been achieved by means of a pressure-sensitive self-adhesive composition compensating substrate unevenness and comprising a base adhesive and an additive, wherein the additive is a microparticulate additive which is insoluble in the base adhesive, does not crosslink with the base adhesive and has a bulk density in the range from 0.05 g/cm³ to 0.25 g/cm³ and an averaged particle diameter in the micrometer range.

The additive chosen is, in accordance with the invention, an additive having a microparticulate structure, in other words an additive which is composed of individual particles and for which the average dimensions of the particles or averaged diameters of the particles are in the micrometer range, i.e. in the range from 1 μm up to a few 100 μm, but overall are smaller than 1 mm. In addition it is necessary for the bulk density of the additive to be situated in the range from 0.05 g/cm³ to 0.25 g/cm³, it being even more advantageous if the microparticulate additive has a bulk density in the range from 0.05 g/cm³ to 0.15 g/cm³, in particular of 0.08 g/cm³. The combination of bulk density and particle size or particle diameter allows the admixing of an additive in a high mass fraction, a considerable volume expansion of the self-adhesive composition, and hence also a distinct reduction in the fraction of base adhesive. It is possible, therefore, to achieve a large volume expansion of the self-adhesive composition for only a slight change in the amount by mass of base adhesive.

It is particularly advantageous in this context if the compact density of the additive (i.e. the density of the additive in the compact, non-particulate state) is chosen such that it is smaller than the density of the base adhesive: for polyacrylate-based base adhesives, for example, an additive with a density of less than 1 g/cm³. In this way it is possible to achieve self-adhesive layers of high thicknesses which have substantially the same basis weight as layers of such self-adhesives that have been produced from base adhesive alone.

The invention further ensures that the additive does not significantly alter the adhesive properties of the self-adhesive composition, by the additive being insoluble in the base adhesive or in one of its constituents and also at the same time not crosslinking with the base adhesive or with one of its constituents, but instead behaving inertly with respect to the base adhesive and/or its constituents. This means that the additive neither enters into a chemical bond with the base adhesive or with one of its constituents, nor alters their crosslinking capacity and crosslinking behaviour, so that the additive does not enter into any lasting chemical interactions, let alone bonds, with the surrounding polymeric base-adhesive matrix. This has the advantage that there can be no unwanted or uncontrollable post-crosslinking reactions of the polymer matrix, whether with the direct participation of the additive or constituents thereof, metal ions or chemical groups on its surface, for example, or under its catalytic influence. This design ensures that the adhesive properties of the self-adhesive composition differ only slightly, overall, from those of the pure base adhesive and that overall, even in the case of a relatively high additive fraction in the self-adhesive composition, an outstanding bond strength is achieved on a lasting basis.

As a result of the combination of the two individual effects obtained by admixing the additive of the invention—the maximum volume expansion of the self-adhesive composition for a given mass fraction of the base adhesive, in conjunction with the minimizing of the adverse effect on the adhesion behaviour of the self-adhesive composition—a self-adhesive composition is obtained, accordingly, which is suitable for providing effective compensation of substrate unevenness and at the same time has outstanding adhesive properties.

Additives which can be employed are any typical particulate additives, provided that they have the properties that are key to the invention. These include the physical properties of bulk density and particle diameter and also the chemical properties of insolubility in a constituent of the base adhesive and crosslinkability with any one of these constituents. From an environmental standpoint it is particularly advantageous in this case to use naturally renewing and biodegradable raw materials, examples being wood flours, wood dusts, cereal flours, starches, spores (such as of Lycopodium clavatum) or the like. A further advantage associated with the use of such additives is that not only are they extremely inexpensive to produce and dispose of but in addition they also frequently have a high degree of internal elasticity and so have the capacity to withstand mechanical loading of the self-adhesive composition without destruction.

A further constituent the self-adhesive composition of the invention comprises is a base adhesive. The base adhesive may in turn comprise the typical constituents, examples being tackifier resins, plasticizers, crosslinkers, crosslinking assistants and antioxidants. As the base adhesive it is possible to use any typical adhesive, such as a solvent-based adhesive, dispersion-based adhesive, curing hot-melt adhesive and/or non-curing hot-melt adhesive, for example. Suitable in this context are all typical systems, especially hot-melt adhesives (known as “hotmelts”) and those based on polyacrylates, on elastomers (thermoplastic and non-thermoplastic) or on polyurethanes (one- or multi-component).

It is advantageous, moreover, for at least 70% of the particles of the microparticulate additive to have a diameter of 200 μm or less, in particular of 100 μm or less, and also for at least 50% of the particles of the microparticulate additive to have a diameter of 80 μm or less. The choice of a particle size or particle diameter distribution of this kind produces a particularly advantageous filling of space within the self-adhesive composition provided with the additive, without thereby causing significant impairment to the mechanical stability or the Theological properties as compared with those of the pure base adhesive. It is further advantageous if the self-adhesive composition comprises the microparticulate additive in a fraction of 50% by weight or less, a weight fraction of between 15% by weight and 35% by weight being especially advantageous.

The invention further provides an adhesive coating which comprises the above pressure-sensitive self-adhesive composition compensating substrate unevenness, the self-adhesive composition being in layer form. An adhesive coating of this kind is a sheetlike-layerwise configuration of one or more adhesives which is formed alone (i.e. unbacked, in the form for example of an adhesive transfer tape) or on a backing material (in the form of adhesive films, tapes or labels, for instance). An adhesive coating of the invention therefore comprises a layering of the self-adhesive composition of the invention alone or together with one or more adhesives. It is especially advantageous in this context if the adhesive coating further comprises a first outer self-adhesive composition formed layerwise on the first side of the layer-form self-adhesive composition and covering said composition on one side. As a result of this first outer self-adhesive composition, it is possible, in addition to the self-adhesive composition's function of compensating unevenness, to use a further adhesive having targetedly controllable parameters, in order thus to obtain specific properties in the end product—for example, control over the modulus or the bond strength to particular substrate materials and/or to the backing material. In this case, the first outer self-adhesive composition is applied to the self-adhesive composition of the invention by conventional methods, by lamination for example. It is advantageous, furthermore, if the adhesive coating further comprises a second outer self-adhesive composition formed layerwise on the second side of the layer-form self-adhesive composition and covering said composition on one side. By this means an unbacked, double-sided self-adhesive tape is obtained in which each of the two adhesives possesses targetedly controllable adhesive properties, and which, moreover, also compensates substrate unevenness. Self-adhesive tape systems of this kind are used, for example, as transfer tapes. For this purpose it is possible first to apply the self-adhesive composition of the invention to a temporary backing, which possesses release properties, a silicone release paper for example, from which it is detached again prior to further coating or else after the coating of the self-adhesive composition with an outer adhesive. It is advantageous, moreover, to use the above pressure-sensitive self-adhesive composition compensating substrate unevenness in order to coat this sheet structure. In that way it is possible to obtain self-adhesive sheet structures which adhere with outstanding bond strength to an uneven substrate. It is particularly advantageous if a self-adhesive tape of this kind comprises a layer-form self-adhesive composition having a layer thickness of 100 μm or more, in particular 200 μm or more. By this means a thick film of self-adhesive composition with a particularly strong compensating function is obtained, which is capable of adhering even to a substrate featuring extraordinary roughness.

As the sheetlike backing for a sheet structure of this kind it is possible to use all conventional backings, examples being those of polyvinyl chloride, polypropylene, cellulose acetate, polyester, paper, fabric, etc., which are of sheetlike design, in the form of tapes, labels or films, for instance.

The invention further provides a method of coating a sheet structure, especially a tapelike sheet structure, which comprises the steps of preparing the above-described pressure-sensitive self-adhesive composition by mixing the particulate additives with the base adhesive, followed by applying the resulting self-adhesive composition to a sheetlike backing, and subsequently aftertreating the resulting coated sheet structure.

The mixing of the additives of the invention with the base adhesive in this method can take place in accordance with conventional mixing techniques, with the assistance of a compounder or the like, for instance, it being advantageous if the additive is mixed homogeneously into the solvent-free base adhesive. It is particularly advantageous in this context if the blending is carried out continuously, in an extruder for example, such as a multi-screw, twin-screw or planetary roller extruder, for instance.

It is advantageous, furthermore, if the adhesives are supplied to the blending operation without having been dried beforehand. Drying of the self-adhesive composition may be carried out advantageously at the end of the operation of incorporation by mixing, and can be accomplished, for example, via an operation of vacuum devolatilization.

The subsequent coating operation is carried out by conventional coating techniques, using conventional coating assemblies, for instance, such as a multi-roll applicator or a calender.

Aftertreatment may comprise all conventional after-treatment steps, such as cleaning, coating and/or post-crosslinking the base adhesive in the self-adhesive composition. The latter serves to increase the cohesion after the shaping of the adhesive coating on the sheetlike backing in the desired layer thickness, and can be carried out by conventional chemical and/or physical methods, for example, catalytically (by adding Lewis acids such as tin chloride to the base adhesive, for instance), thermally, photochemically or by means of high-energy radiation. This kind of post-crosslinking offers the advantage that the self-adhesive composition is still shapeable during application in the coating assembly and does not acquire the desired final viscosity until afterwards, in the aftertreatment.

For the purpose of illustration of the invention, a description is given below, by way of example, of the production of a self-adhesive sheet structure in web form:

The solvent-free base adhesive contained 42.5% by weight rubber (NR air dried sheets), 21.25% by weight resin 731D (tackifier resin from Eastman), 18.75% by weight Escorez 1202 (tackifier resin from ExxonMobil Chemical), 7.5% by weight Dercolyte S115 (terpene resin from DRT), 5.0% by weight active zinc oxide (as colorant and crosslinking catalyst), 3.75% by weight Ondina G 33 (oil from Shell) and 1.25% by weight Lowinox AH25 (stabilizer from Chemtura Corporation).

The particulate additive used was predried screened wood flour (type C160) (softwood-based) from Holzmühle Westerkamp GmbH; bulk density: 0.105 g/cm³; particle size distribution: 100% of the particles having a diameter of less than 100 μm and 53% of the particles having a diameter of less than 80 μm) in a weight fraction of 20% of the total mass.

The solid components were introduced via gravimetric metering devices into the feed section of a planetary roller extruder equipped with three roller cylinders (ENTEX Rust & Mitschke). The Escorez 1202 resin was injected at 160° C. as a melt after the first third of the barrel length of the planetary roller extruder, the Ondina G 33 oil after the second third of the barrel length.

The overall throughput of the planetary roller extruder was 42 kg/h at a central-spindle speed of 120 min⁻¹. The extruder's central spindle was operated with cooling water at 12° C.; the roller cylinders were heated at 90° C. In the last roller cylinder of the planetary roller extruder, the self-adhesive composition was evacuated via an opening in the extruder and so freed from air and moisture.

The self-adhesive composition thus prepared was supplied via a downstream single-screw extruder to the first roll nip of a triple-roll calender (working width: 350 mm). Preliminary shaping of the adhesive coating took place between the first and second rolls of the calender. The desired thickness of the adhesive coating, 100 μm, was obtained by checking the width of the nip between the second and third rolls of the calender. The roll temperature was 95° C. for a web speed of 25 m/min, a ratio of 1:4 in the differential speed of the two calender rolls being set between the second and third calender rolls.

The self-adhesive composition was coated directly onto a double-sidedly siliconized release paper. In an aftertreatment, then, a laminating station transferred the adhesive coating to a commercially customary roll spun-rayon fabric (yarn density: 19/17).

The self-adhesive tape produced in this way exhibited very good adhesion to uneven substrates.

What is claimed is:

1. A pressure-sensitive self-adhesive composition that compensates for substrate unevenness and comprises a base adhesive and an additive, wherein the additive is a microparticulate additive which is insoluble in the base adhesive, does not crosslink with the base adhesive and has a bulk density in the range from 0.05 g/cm³ to 0.25 g/cm³ and an averaged particle diameter in the micrometer range.

2. Self-adhesive composition according to claim 1, wherein the microparticulate additive has a bulk density in the range from 0.05 g/cm³ to 0.15 g/cm³.

3. Self-adhesive composition according to claim 1, wherein at least 70% of the particles of the microparticulate additive have a diameter of 200 μm or less and also at least 50% of the particles of the microparticulate additive have a diameter of 80 μm or less.

4. Self-adhesive composition according to claim 3, wherein at least 70% of the particles of the micro-particulate additive have a diameter of 100 μm or less and also at least 50% of the particles of the microparticulate additive have a diameter of 80 μm or less.

5. Self-adhesive composition according to claim 1, wherein the self-adhesive composition comprises the microparticulate additive in a fraction of 50% by weight or less.

6. A method of forming an adhesive bond between a self-adhesive composition and a substrate and at the same time compensating for any substrate unevenness, said method comprising adhering to an uneven substrate a self-adhesive composition according to claim 1.

7. An adhesive coating comprising a pressure-sensitive self-adhesive composition according to claim 1, the self-adhesive composition being in layer form.

8. Adhesive coating according to claim 7, further comprising a first outer self-adhesive composition formed layerwise on a first side of the layer-form self-adhesive composition and covering said layer-form self-adhesive composition on one side.

9. Adhesive coating according to claim 8, further comprising a second outer self-adhesive composition formed layerwise on a second side of the layer-form self-adhesive composition and covering said layer-form self-adhesive composition on one side.

10. A self-adhesive sheet structure comprising a backing and an adhesive coating according to claim 7.

11. Sheet structure according to claim 10, wherein the layer-form self-adhesive composition has a layer thickness of 100 μm or more.

12. A method of coating a sheet structure comprising the steps of preparing the pressure-sensitive self-adhesive composition according to claim 1 by mixing the particulate additives with the base adhesive, followed by applying the resulting self-adhesive composition to a sheetlike backing, and aftertreating the resulting coated sheet structure.
